(19) United States
(12) Patent Application Publication
(10) Pub. No.: US 2003/0015084 A1
(43) Pub. Date: Jan. 23, 2003

(54) General synthesizer, synthesizer driver, synthesizer matrix and method for controlling a synthesizer

(76) Inventor: Peter Bengtson, Vallentuna (SE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 09/803,458

(22) Filed: Mar. 9, 2001

(30) Foreign Application Priority Data
Mar. 10, 2000 (SE) (SE) 0000825-0

(51) Int. Cl. G10H 1/06

(52) U.S. Cl. 84/622

(57) ABSTRACT

A general synthesizer, driver, matrix, and method. The synthesizer includes an application that maps a musical representation into vectors that include pitch, duration, and descriptors; at least one matrix for mapping descriptors into specific attributes; a driver for creating data flow using vectors and a matrix; and a device controlled by the data flow. The driver provides an API that includes descriptors manipulable to enhance playback. A matrix is organized with instrument subgroup nodes and instrument leaves. A method involves building a list of musical objects that each comprise a note or chord, translating each musical object into recursive lists of intermediate objects that include pitch, duration, cycling data, and descriptors. Each intermediate object is translated using cyclic information to describe early musical objects. Each early object is translated into a control event and a channel and synthesizer is selected for each event.

### OVERVIEW

Knowledge entrance requirements:

The MIDI standard and how it is used to communicate by synthesizers, computers and other components.

Basic music theory, such as which means of expression are used by composers and musicians to give form to their music and how to denote this with symbols and text in traditional sheet music.

Software development and programming.

The invention concerns one specific step of several involved in the process of generating sophisticated playback from music e.g. in a form such as sheet music in digital form, usually interpreted from paper by a number of musicians playing together where the goal of the computerized playback usually is to imitate this manner of human playback and to parameterize or to further control the playback.

See table 1 below, which gives an overview of how generalized synthesizers fit into other closely related disciplines. This document describes the different components of and the necessity of a Generalized Synthesizers abstraction to principally solve the intricate problems involved and the necessity of an actual implementation of the different components of Generalized Synthesizers in any working solution of satisfactory quality and flexibility.

TABLE 1
One sample view of different abstraction layers and what
they typically concern or know about when considering the
problem of generating sophisticated artificial playback of
music. Each layer needs to be built based upon the
following layer and each layer and layer transition has
it own unique problems to solve.

| | | |
|---|---|---|
| Music | • | Music as perceived by musicians, composers or anyone appreciating |
| | | a good piece of music. |
| | • | Moods |
| | • | Expressing feelings |
| | • | How to influence and affect the listener in a wanted direction |
| | • | Music in art, culture and history |
| A music | • | Managing pieces, part & scores layouts, pages, systems, individual |
| notation | | musicians, instruments, staves, bars and layers of musical symbols |
| program | | and playing instructions in text |
| | • | Inputting parts of music through a computer keyboard, a synthesizer |
| | | keyboard or by file import (in a format such as MIDI which can only |
| | | contain parts of the needed information) |
| | • | Playback, intelligently generating MIDI and controlling synthesizers |
| | • | Printing sheet music |
| Generalized | • | Instruments |
| Synthesizers | • | Orchestration |
| | • | Nuances, articulations and other playing/conducting instructions |
| | • | Interpreting sheet music (even when there are no playing instructions |
| | | except the music itself) |
| MIDI | • | Specific patch names and their sounds |
| | • | Velocity values from 0 to 127 and other such MIDI attributes |
| | • | MIDI events on a millisecond (or more detailed) scale, e.g. to set a |
| | | new MIDI attribute |
| Specific | • | Wave forms and their patch numbers |
| synthesizers | • | Banks of wave form patches |
| | • | Real-time signal processing |
| | • | Sending signals to a speaker or other device |
| Electronics | • | Speaker construction and audio physics |
| | • | Transistors and amplifiers |
| | • | Integrated circuits |
| | • | General hardware development (memory management, signal |
| | | processors, VHDL, ASIC etc) |

Note: the music notation program above can be replaced by any other component to control synthesizers or to help generate sophisticated playback such as (1) a sequencer (in hardware or software), (2) a file format based on Generalized Synthesizers and a sub format such as MIDI or (3) a complete synthesizer (hardware or software). The specific problems of generating playback at this abstraction level are still the same and are still solved by the Generalized Synthesizers invention and specifically solved by one of its implementations.

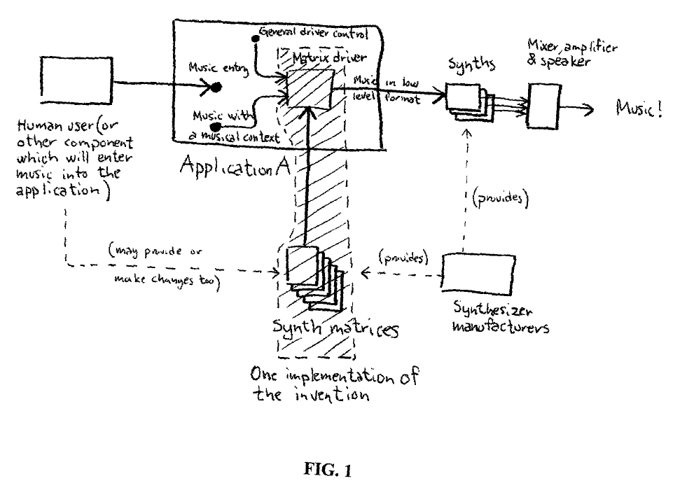

See FIG. 1 further down for an example of a physical setup where one implementation of the invention constitutes one part.

### BACKGROUND

0 Music in a Musical Context

An instrument played by a human being exhibits many varied characteristics: the sounds produced may be rich in overtones, loud or soft, their attacks may be rapid or gradual, the duration may be slightly prolonged or shortened, the tone may be slightly displaced, the tempo might accelerate slightly and so forth, all depending on the musical context. What makes a performance sound “human” and “live” (both highly subjective factors), is the continual change of many different parameters from note to note, or even within single notes.

1 Synthesizers and Patch Banks

Large synths may have multiple patches for each instrument, for instance, for a French Horn:

a) a slow horn sound, fading in slowly

b) a soft horn sound with normal attack

c) a loud horn sound

d) a loud horn sound played by a muted horn

String sounds might typically include:

a) normal attack

b) fast attack

c) slow attack

d) pizzicato, where the player plucks the strings

e) tremolo

f) sul ponticello, glassy sounds

g) harmonics, high flute-like, transparent sounds

h) marcato, very short and loud notes

There is no standardization of patches, apart from a small set called General MIDI (GM), which defines 127 standard patch sounds. A GM compatible synth (short for synthesizer) is guaranteed to play a piano sound when patch number 1 is selected, for instance. However, non-GM synths are common, and 127 patches do not leave room for more than one kind of sound for each instrument.

Apart from this, there is no standardized order or numbering between synthesizers—all are different. Some synthesizers have few instrument-specific sounds, some have quite a few. For instance, a synthesizer with vocal patches might have patches for each vowel, and/or for female and male voices, choruses and so forth.

2 Problems with Current Tools

Current tools (software and/or hardware) typically let the user specify one specific patch for each instrument used. Also, they usually require the user to specify one particular channel on one particular synthesizer to use. In effect, the association between an instrument, a synthesizer, a channel and a patch is completely static.

Some programs offer the user means of changing patches at indicated places in a piece. For instance a pizzicato passage might require the user to insert a patch change where the passage is to begin, and another patch change when the pizzicato passage ends.

This manual assignment has many disadvantages and create a multitude of problems. The principal one is this: when there is a need to switch to another synthesizer or combination of synthesizers, all the patch assignments have to be redone, since they were static in the first place: tailored specifically for a specific channel on a specific synthesizer. Therefore, changing synthesizers and patch assignments is not trivial. It might take many weeks in a complex piece of music, a very laborious procedure.

For this reason, with hitherto available technology, users tend to shy away from changing patches, since pieces become difficult or impossible to move to another setup or another studio. Again, as a result, the music sounds mechanical and dead.

Another disadvantage to this static allocation method is that instruments that are silent still will occupy channels, which potentially could be used for other purposes. For this reasons, each synthesizer, using this static method, typically supports no more than 16 instruments—one per synthesizer channel.

FIG. 1 shows a simple example of a context of one implementation of the invention.

### COMPONENTS OF THE GENERALIZED SYNTHESIZER INVENTION

The components of which the Generalized Synthesizer consists are:

An instrument library.

A file format here named the synth matrix file format (synthesizer matrix file format) and its description/documentation and technical use.

A number of files collectively called synth matrices where each synth matrix refers to a file in the file format above for a specific synthesizer brand and name—every synthesizer to be used needs a synth matrix (this is never a hindrance since a synthesizer can always default to a GM synth, even though this means lower quality playback).

The specific part, here called a matrix driver, of a computer program (A) or of any other software or hardware component (A) which may use a collection of synth matrices to produce enhanced playback independent of what synthesizer/synthesizers is actually used for playback. The program will interface the matrix driver which in turn will interface the specific synthesizers actually used at playback.

A set of vocabularies and the set of methods needed to process a purely musical vocabulary by several steps into a low level vocabulary understood by the interfaced synthesizers (or other hardware and/or software components) where intermediate vocabularies are suitable to process and manipulate different aspects of music along with its musical context.

External components needed for actual playback:

A complete component (A) as described in the last paragraph, besides the matrix driver itself, which manages music in some manner, for example to be entered and modified by a human user.

A lower level format, for example MIDI, into which the matrix driver can translate music from the internal representation of music in the component (A) with the help of synth matrixes and matrix driver to suit the actual synthesizers and to directly control them.

One or several synthesizers in hardware or software which are controllable by the lower level format above and means of connecting these synthesizers to the program (A), for example by MIDI input and output ports together with MIDI cables and audio cables together with a mixer, amplifier and a speaker system.

3 The Instrument Library

The instrument library is the common reference point of synth matrices, matrix drivers and the application programs to reference instruments and to specify instrument behavior or simple parameterized values. Generally it is a tree structure of nodes and leaves where information can be stored in both nodes and leaves. For instance:

Woodwind instruments

Flute instruments

Flutes

Piccolo

Flute

Alto Flute

Bass Flute

Recorders

Sopranino Recorder

Soprano Recorder

Alto Recorder

Tenor Recorder

Bass Recorder

Pan Flute

Reed instruments

Single-reed instruments

Clarinets

Clarinet in E flat

Clarinet in D

Clarinet in C

Clarinet in Bb

Clarinet in A

Bass Clarinet

Double-reed instruments

Oboes

Oboe

Cor Anglais

Heckelphone

Bassoons

Bassoon

Contrabassoon

Those marked with an asterisk are generic names for groups of instruments and sub-group names (internal tree nodes). The other names are actual instrument names (tree leaves). The purpose is to allow the application program, the matrix driver, the synth matrix author and the end user of the application program to refer to whole groups of instruments and specify general behavior and characteristics at a close-to-root level for many instruments simultaneously and at the same time to allow detailed tailoring at a close-to-leaf level or in individual instruments.

Referring to a certain characteristics of an instrument where this characteristics has not been specified is then equivalent of referring to the closest node upwards in the hierarchy where that characteristics was specified. Since instruments are grouped and sub-grouped in several levels by nature, this is of immense value.

For a partial listing of an instrument library used in one actual implementation of this part of the invention see Appendix A.

4 The Matrix Driver

The term matrix driver can be compared to the general driver terminology for computers (e.g. different printer drivers to manage different printer models). The application program never has to know anything about synthesizers except the general interface to the driver. But the meaningfulness of this idea stretches much further by the design of Generalized Synthesizers since synth matrixes are constructed to be changed, trimmed and replaced at will by for example high demanding end user of the application in the simplest possible manner.

The purpose of the matrix driver is roughly threefold: (1) to directly support the notion of a musical context through a special descriptor set, (2) to handle other directly musically related instrument specific details and (3) to automatically take care of low level patch and resource allocation (such as MIDI channels and MIDI patch numbers, in the MIDI case). See the table below where some of the discussion refers to details in the “Technical synth matrix details” section further down.

| Musical | The purpose of the matrix driver is to transform music with a musical | |
|---|---|---|
| context | context into a lower format description such as MIDI, which can be | |
| | interpreted directly by synthesizers (musical context should be interpreted | |
| | in the sense which is mentioned in the Background earlier). The musical | |
| | context is maintained by the application program, for example by simple | |
| | table look-up interpretation of playing instructions or by advanced | |
| | analysis of the music to be played using artificial intelligence algorithms. | |
| | The method for obtaining musical context is irrelevant - what is relevant | |
| | is that this musical context, of course, is of great importance for playback. | |
| | The matrix driver provides the application program (hardware or | |
| | software) with an API (Application Programmers Interface) used by the | |
| | program to transfer music together with its musical context to the matrix | |
| | driver. The API provides a minimal but sufficient set of descriptors which | |
| | are the basic “colors” the matrix driver can blend in different ways and | |
| | with which it can “paint” the music to enhance the playback to cover not | |
| | only pitches, durations and sound banks etc but to actually convey the | |
| | musical context. It is the responsibility of the application to maintain | |
| | (typically by parameterizing) the musical context in a form which can be | |
| | transferred by the API to the matrix driver. And it is the responsibility of | |
| | the matrix driver to translate this music and context, through the | |
| | descriptors of the API, into the lower leveled format or formats which the | |
| | synthesizers (or other hard/software) directly understands. The elements | |
| | of this lower leveled format are here called attributes - so the matrix | |
| | driver translates sets of descriptors into sets of attributes. | |
| | Exactly how each color is interpreted depends both on the synth matrix & | |
| | synth (or other soft/hardware) being used and on which instrument is | |
| | being used - the same musical context will yield different low level | |
| | values varying from instrument to instrument and from synth to synth. For | |
| | example, several different patches will be used for one violin instrument | |
| | depending on if it is plucked or if it is played with a bow, and cross patch | |
| | fading can be used to build up a crescendo starting with a soft sounding | |
| | violin patch which gradually fades into a more sharp sounding patch | |
| | while volume is increased gradually at the same time. | |
| Instrument | There are several instrument specific mechanisms available through the | |
| specific | API, similar to the cross patch fading in the paragraph above: | |
| details | • | Cross patch fading. The application has only to specify general or |
| | | specific preferences for when this is allowed and the matrix driver |
| | | then asks the synth matrix file in question if there are any patches to |
| | | cross fade between. The crescendo is just one example and the same |
| | | mechanism can be used for example to gradually go from tastiera to |
| | | ponticiello on a guitar or to play from amoroso to con fuoco on any |
| | | instrument as long as separate patches are provided in the synth |
| | | matrix for these descriptors on the instruments they were to be |
| | | used on. |
| | • | Trills. The matrix driver knows that different instruments have |
| | | different lengths of their trill notes, for example compare a slow tuba |
| | | with a quick piccolo flute. These timing parameters can also be |
| | | specified on a per patch or instrument basis in the synth matrices. |
| | • | The same situation applies to glissandi, an arpeggio, a tremolo etc as |
| | | to the trill above - their behavior can be specified per instrument or |
| | | patch basis if the default versions are not adequate for a certain kind |
| | | of music. |
| | • | Expanding single voice instruments. If a single voice instrument is |
| | | defined with one or several multiple voice patches then the application |
| | | program can tell the matrix driver how many duplicates are used for |
| | | each instrument. As long as the music of the instrument is |
| | | polyphonous the single voice patch is used for each part but when all |
| | | parts play the same music then the multiple voice patch is used. |
| | • | Imploding multiple voice instruments. Just as above but a new way to |
| | | apply it - some instruments are considered to be a collection of |
| | | individuals such as a choir or a five part horn section. As long as the |
| | | horn section plays in monophony the normal patch is used but if the |
| | | horn section splits up into a five part passage then it would, with the |
| | | standard patch, sound as if played by 25 horns! So at least the volume |
| | | should be adjusted, and if a single instrument patch exists it should be |
| | | used instead. |
| | • | Register and patch flaws. Some patches sound well only in part of the |
| | | register and an instrument should not only have the possibility to be |
| | | assigned different patches (or other low level attributes) for different |
| | | musical contexts but also to be assigned different patches across |
| | | different parts of the register. |
| | • | Cross register fading. If two patches differ a lot then they will need to |
| | | be “cross register faded” to yield a smoother transition across the |
| | | register when patches are changed. This requires extra resources, in |
| | | the case of MIDI, an extra channel is needed. (The situation is extra |
| | | interesting for a prolonged glissando across both registers.) |
| | • | Patch timing flaws. If a patch has a very delayed and/or smooth attack |
| | | it might not be usable unless it is offset by a constant number of |
| | | milliseconds. This would be notable when two instruments with patch |
| | | timing flaws in opposite directions play a duet or if two such patches |
| | | are used to compensate for register flaws. |
| Dynamic | The third problem solved by the matrix driver is dynamic channel | |
| channel | allocation, i.e. to optimize the usage of MIDI channels (or equivalent term | |
| allocation | in other low level format) which means doing three things: | |
| | • | Two or more instruments with the same MIDI patch number (or other |
| | | low level identifier in other formats) may share the same channel if |
| | | their musical context does not differ in an incompatible way. For |
| | | optimizations, the instruments may be allowed to differ in musical |
| | | context in an incompatible way. (Differing in musical context in an |
| | | incompatible way means, in the MIDI case, that the two contexts for |
| | | at least two active parts yield differing low level attributes which may |
| | | be applied only to a whole channel and not to an individual part. |
| | | Velocity is an example of a compatible attribute since it can be used |
| | | on separate notes while pitch bend/pitch offset is an incompatible |
| | | attribute since it is always applied on a whole channel.) |
| | • | An instrument which is temporarily silent does not need a MIDI |
| | | channel, and thus allows other instrument to be played back on that |
| | | channel (as long as the other instrument is silent). |
| | • | If the user or application wants to assign certain instruments or patch |
| | | numbers to fixed channels this will of course be considered (this is the |
| | | simpler case). Moreover, if the user or application wants to assign |
| | | certain instruments or patches to a specific synth this is obviously |
| | | considered since different synthesizers might be specialized on |
| | | different instruments and patches. The first case of static channel |
| | | allocation on the other hand might be desirable when MIDI is |
| | | exported as a file to be imported by another pure MIDI application. |
| | In practice this means that the application program need not handle low | |
| | level details such as channels (of course, unless instruments are explicitly | |
| | statically assigned to channels) which allows several more instruments to | |
| | be played on one synth since all instruments seldom sound at the same | |
| | time and since similar instruments often follow the same musical context. | |
| | If the number of instruments during playback still does not fit into the | |
| | number of available channels then the matrix driver may be set up to | |
| | handle the situation in different ways: | |
| | • | Each instrument which has to be skipped is registered and the user is |
| | | notified after or before playback - no optimizations are performed. |
| | • | Optimize the usage of channels such that identical instruments use the |
| | | same musical context as suggested in the first point in the list above. |
| | | When there are several candidates to merge in this way, a crude |
| | | metering is required for musical contexts such that it can be decided |
| | | which one of two musical contexts is closest to a third - the closest |
| | | should be merged. Such a metering can be constructed by summing |
| | | the relative difference (between 0 and 1) for each attribute in the |
| | | output vector (for an explanation on this word see the “Technical |
| | | synth matrix details” section below). A second and better metering is |
| | | to do the same sum but to weight the different attributes differently |
| | | such that those attributes that are generally easier to hear have higher |
| | | weights. |
| | • | Optimize the usage of channels such that the same patch and exactly |
| | | the same musical context is used for similar instruments. This requires |
| | | a metering like the above to be combined (through mean values such |
| | | as sqrt(a * b), a * b/(a + b), (a + b)/2 or weighted versions) with a second |
| | | metering which gives the “distance in sound“ between two instrument |
| | | names. Two simple ways to obtain such a second metering is to use |
| | | the distance in the hierarchic instrument library (i.e. how many nodes |
| | | that separate two instruments) or to have a fixed preset square table |
| | | telling, for each instrument, the “sound distance” to every other |
| | | instrument in the instrument library. |

Synth Matrices

The chief purpose of a matrix file is to fill in the basic colors to be used by the matrix driver for a specific instrument from the instrument library on a specific synth brand and model—each matrix file lists instruments and how their musical context should be interpreted for a specific synth.

One entry in this listing consists of (1) an instrument or instrument group name, (2) the descriptor to be specified and (3) a listing of which attributes should be used for that instrument and descriptor. The listing (3) in turn consists of attribute names along with parameters (in the simplest form just a number) to specify to what degree that attribute contributes to the resulting attribute parameter. Several descriptors may contribute with the same attribute and typically the result is obtained by summing the individual components.

The second purpose of synth matrices is to generally specify the behavior of play back and the affect of indications and symbols in the music on play back. For example a trill, an arpeggio, a tremolo and a glissando can be modified in their behavior either by simple parameterization or by scripting (i.e. simple pieces of code specified by the user which will be interpreted at play back).

See Appendix B for some sample synth matrix files actually used in a working software application using one implementation of the invention.

The Synth Matrix File Format

The synth matrix file format in detail describes the form in which the synth matrices must be formulated to be correctly interpreted by the matrix driver. For example, the name of a matrix file must match the name of the synth it describes, there may be any text comments disregarded by the matrix file interpreter in the file, there may be any number of empty lines and non-empty and non-commented lines must be of an exact entry form listing instrument name. descriptor name and attribute list all separated by a blank space etc.

There is one optional exception in the file naming and syntax which is the default matrix file which is independent of the synths actually used. This file has a special name and it is used to generically add instruments to the instrument library and to generically add new descriptors to the basic “coloring set” of the matrix driver or to change the behaviour of old descriptors. This allows the application program to be enhanced such that the matrix driver, the instrument library and the synth matrix file format and files (i.e. all the components of the Generalized Synthesizers invention) are allowed to handle the enhancement in an automated and flexible manner, should it be needed. One can immediately see the value of adding new instruments—seeing the value of adding new attributes is trickier. But this would indeed be desired for example if a synthesizer manufacturer releases a new synth which has patches using MIDI slots hitherto not used (empty slots only named) to enhance playback in a new manner or if it uses old slots in a new manner which in some way increases the possibility to enhance playback.

Behavior provided in the general matrix can be overridden per patch basis in the synth matrix files if needed.

The synth matrix files are either read and interpreted during program start, and re-read at command from the application through a command to the matrix driver (for example when a user has changed a synth matrix) or the synth matrices can be compiled to a more compact form which is read at greater speed at startup. Changing a synth matrix will then require recompilation of that file or all the synth matrix files.

Sets of Musical Vocabularies

This is a detailed computational model and a sophisticated solution of how to process music along with its musical context from a more or less abstract level through a series of internediate vocabularies, and transitions down into low level formats understood by e.g. synthesizers and sound effect components (see “Details on musical vocabularies” further down).

Technical Synth Matrix Details

In the simplest form a descriptor consists of entries for one or several attributes, examples of these attributes are given below, where each entry is specified by a parameter:

Synth patch number,

volume level,

velocity level,

pan position (from left to right in the stereo image)

microtonal modification (glissandos, quartertones, etc)

reverb amount

the number of octaves to shift the note,

the amount of microtonal frequency shifting,

the amount of milliseconds to offset the onset of the note to compensate for a slow attack, or to create an even legato,

the amount of milliseconds to offset the release of the to compensate for a slow release, or to create an even legato,

positioning data, e.g. for viewing the instruments as played by an orchestra which would mean giving each instrument a position such as a distance and an angle from the conductors point of view. Pan position (left/right) combined with volume (distance) and reverb (distance) could “audiolize” the positioning information in the simplest case.

etc.

Call the set of attribute entries for a descriptor an output vector. A simple descriptor can have an output vector consisting of only one attribute entry while another descriptor can fill up the whole list above to form a completely filled output vector.

Call the list itself above an output vocabulary. The larger the vocabulary the more of the musical context can be conveyed in general and every output vector is described in terms of the output vocabulary.

To make the list above more complete, any MIDI event or attribute can be added. But the list can clearly be seen to consist of several attributes of other kinds such as the positioning data which combines several MIDI attributes or the millisecond offsets which affects the behavior of the matrix driver. This is an explicit purpose of the matrix driver in combination with synth matrices, namely to view the output vocabulary as a layer which is on a slightly higher level of abstraction than the lower leveled format, e.g. MIDI, giving the writer of the synth matrix some extra freedom even at the most detailed level furthest away from abstract music. An example of descriptors to form a descriptor set might be:

legato/staccato playing, etc,

whether mutes are used or not,

the amount of vibrato,

‘forte’ or ‘piano’ (that is, loud or soft),

playing modes such as ‘pizzicato’, rim shot, etc,

etc.

Call such a list or set an input vocabulary. Each descriptor has at least a name to identify it and a state. The state might consist of an on/off property or a parameterization such as a range between zero and one (covering “not used at all”, “used a little bit” and “used as much as possible”). Optionally the state might be more complex such as a pitch or pitch interval.

Call the collection of all descriptors with their states the driver state or an input vector. The driver state is expressed completely in terms of the input vocabulary and each descriptor in the driver state will contribute to the resulting output vector. The simplest way to enter a new driver state is to set a new input vector even if a more suitable way might be to change the driver states in incremental steps—but this is the responsibility of the application program.

The whole point of the descriptor set is to be as minimal as possible (i.e. to have as few descriptors as possible) while at the same time being large enough to express a musical context, and more specifically, large enough to be able to express the output vocabulary but in a language much closer to music than to hardware details.

5 Attribute Combination

Since several descriptors might contain the same attribute and since the driver state might contain two or more descriptors containing the same attribute there must be a way of combining several parameters of the same attribute to form a resulting parameter in the output vector where the attribute only occurs once.

The matrix driver leaves a number of options to the application program to configure at will. These options are (how to handle several parameters for one attribute):

Ignore all but the first attribute, in order of appearance of descriptors in the synth matrix file in question,

ignore all but the final attribute, in order of appearance of descriptors in the synth matrix file in question,

report a second descriptor (in order of appearance of descriptors in the synth matrix file in question) using the same attribute as a previous descriptor as an error when the synth matrix files are read,

- - -

sum all the components, multiply all the components, etc,

maximize over all the components, minimize over all the components, take an average of all the components etc,

apply a general function to the list of components where the general function is specified for each synth matrix file it is active in and for each attribute it should act on, for example in the form of common lisp code to be interpreted by the matrix driver such as #'(lambda (attribute-list) (reduce'+attribute-list)) which could be interpreted and evaluated in analogy with (funcall #'(lambda (attribute-list) (reduce '+attribute-list)) (list 1 2 3 4)) to simply give the result 10 which is equivalent to summing the components as in a previous point above. The general form would require each attribute parameters to be accompanied by an identifier of the descriptor which caused so that different parameters can be processed in different manners depending on what generated them. An alternative is to give the function a reference to the complete musical context.

In particular 1-3 may be combined with:

Allow descriptor combinations to be specified so that the resulting attribute parameter is manually entered for the case when two descriptors are used at the same time.

This allows some flexibility while at the same time admitting a simpler form of the matrix driver, if desired.

Finally the most general form of attribute combination is:

Allow descriptor combinations to be manually specified so that the resulting attribute parameter is obtained from the manually specified combination, if present and if marked to override default or general functions such as the 1-6 above, but from the chosen function 1-7 above if there exists no manually specified combination. In other words: use the manual specification to combine if present, otherwise use a default combiner behavior.

Details on Musical Vocabularies

Below is a sketch of the method, step by step, used for translation:

I. From the application's use of the API, the matrix driver can directly build a list of application atomic musical objects along with their contexts—call these objects AAMOs. Each AAMO consists of one note or a chord with high level descriptors such as trill indication, arpeggio inidcation, tremolo indication, an indication defined in the synth matrix or no special indication at all. A chord is considered to be an atom since exactly the same descriptors and musical context is valid for all its components. A note with grace notes attached to it is also considered to be atomic since grace notes can not exist on their own.

The music consists of AAMOs in sequence (e.g. a monophone melody) as well as AAMOs in parallell (e.g. a string quartet arrangement) together with musical context defined both locally for one sub structure only or globally, for all parallell AAMOs. Examples of sub structures are individual instruments, individual staves in these instruments or individual layers of music inside these staves.

II. Each AAMO atom is broken apart and translated into a recursive lists of internediate musical objects, a LIMO, to allow further processing (being a recursive list means that the LIMO consists of a list of atoms and possibly more LIMOs in the same list). Typically an AAMO with a trill is translated into several LIMO elements to reflect the fact that a trill consists of several notes when played back. A more complex example is an AAMO consisting of a chord with grace notes, where the grace notes may also be chords—this is a case which requires the LIMO to recursively contain other LIMOs where a second such LIMO consists of a list of atoms, i.e. the notes of a grace-note chord. The LIMO is not considered atomic (regardless of the fact if it has sub structure or not) since its components could be assigned different MIDI patches due to register dependant patch assignments for example.

The atomic elements of a LIMO consists of pitch and duration together with a list of cycling data such that pitch and duration information need not be repeated even if the LIMO represents such cyclic repetitions. Besides the pith & duration and the cycling data the LIMO elements also consist of a list of descriptors. At this level it is possible to translate parts of the musical context descriptors into specific patches if these are indicated by the synth matrix—if there are no specified patches then the descriptors remain to be translated in later steps. For example a pizzicato patch can be chosen here, but if no such patch exists then notes will need to be shortened instead in the following steps (such operations can not be performed yet because the LIMO contains cyclic data without sufficient details yet).

III. Each element in the LIMO is translated, using the cyclic information to directly describe one or two early MIDI musical objects, EMMOs. An EMMO is not in the MIDI format but can be directly translated into a MIDI event. The reason one LIMO can yield two EMMOs is e.g. cross patch fading where a note (one LIMO element) can start in one patch and end up in another patch.

At this point every element (every EMMO) can be assigned specific descriptor values obtained from the general descriptor which may consist of scripted functions etc, together with the explicit start and duration values (no cyclic data remains). If a pizzicato is to be simulated (i.e. if there was no pizzicato patch) then each note can now be shortened, since each element of a LIMO is broken out as one or two separate EMMO's with separate durations.

IV. Each EMMO is translated to a synthesizer specific MIDI event, SSME. If a patch has not been selected yet it is selected and the contribution of each descriptor is combined to form all the low level attributes of MIDI. Also a channel and synth must be chosen for each SSME in a manner suggested in the “Dynamic channel allocation” paragraph earlier.

To continue the pizzicato example above, the SSMEs might need to have a negative delay (i.e. SSMEs describing a note down MIDI event need to be sent a bit earlier) if the specific synth matrix tells the matrix driver that this patch is a bit too slow, that is that the main attack of a note comes a bit after the note down event is received by the synth.

For example, to have a correct glissando each element of a LIMO might be translated to any number of EMMOs, one extra element for each octave the glissando spans. This is because a pitch bend is used to produce the glissando and because a pitch bend can usually stretch no more than an octave. To have a continuous sound all notes must start and end simultaneously (to avoid “re-attacks”) but in a way such that all notes except one is muted all the time.

Also little is said about how parameterization of descriptors are implemented. Typically a hairpin, for example, is saved with a starting and ending time together with two values finally ending up translated to MIDI volume attributes, where the hairpin is saved as a linear segment between these two starting & ending values so that intermediate values can be obtained in the final transition from EMMOs to SSMEs.

6 The API

The API of the matrix driver must allow the application program to completely describe each AAMO which means listing its instrument, staff, layer, note pitches, duration, rhythmical position (start time), high levelled descriptors for each note and high level descriptors for the ongoing musical context.

The ongoing musical context must also be specified from start to end (in time), if desired, for each layer, staff, instrument, instrument group or music as a whole where the most specific context will be chosen automatically by the matrix driver for each AAMO (if an AAMO has a specific layer context then that context is chosen, if not the staff context is chosen if present, if not the instrument context is chosen etc. until the topmost level is reached). Concrete examples of high level descriptors are ritardando, pianissimo, amoroso, tenuto, hairpin (crescendo) etc. For individual layers there are also things to consider such as slurs and even beams to affect playback.

The high level descriptors connected to each note on the other hand are things such as trill indications, arpeggio indications, grace notes, tremolo indications, marcato indications, staccato indications, special playing modes (e.g. plucked or with a mute) etc.

Beside these purely descriptive functions there must also be a set of functions for general control such as to tell the matrix driver to re-read the synth matrices (if they have been changed) or to override settings such as using a faster tempo than what is notated in the piece.

Problems Solved by the Generalized Synthesizers Invention

The idea of Generalized Synthesizers is to solve a number of problems with previous attempts to create playback generating components (software or hardware) and altogether to enable end users of an application, application developers and synth matrix writers to work at a much higher level of abstraction than what is permitted when using low level formats such as MIDI to control synthesizers or to generate lower level formatted files or traffic. The term application refers to both hardware and software (and their combination) and includes e.g. synthesizers.

Here are some problems solved by the Generalized Synthesizers invention:

| | | |
|---|---|---|
| Dynamic | • | Developers and end users do not need to directly think in terms of low |
| channel and | | level MIDI channels but are allowed to think in terms of instruments |
| patch | | instead which is much closer to abstract music. |
| allocation | • | Developers and end users do not need to directly think in terms of low |
| | | level MIDI patches but are allowed to think in terms of instruments |
| | | instead which is much closer to abstract music. The musical context is |
| | | part of the design of Generalized Synthesizers and an implementation |
| | | of Generalized Synthesizers lets the innermost playback interface |
| | | (namely the matrix driver) carry information about patches and when |
| | | they should be used. |
| | • | The number of instruments used during playback can be greatly |
| | | increased compared to traditional static channel & patch assignment |
| | | and manual scheduling is altogether avoided. |
| | • | If there is no way to fit the number of instrument into the available |
| | | number of channels during playback, the instrument to be neglected |
| | | can be selected and optimized in such a way that the impact on the |
| | | resulting sound can be optimized in some sense. |
| Portability | • | Managing several synths and porting a studio setup from one set of |
| | | synthesizers to another without loss of quality or massive manual |
| | | modifications, i.e. without any manual modification at all becomes a |
| | | reality. |
| | • | The above makes it possible to share music files based on MIDI for |
| | | playback among several users, e.g. for educational purposes or to sell |
| | | such files to users with different studio set ups/synthesizer sets |
| | | without the loss of quality present in current tools and systems. |
| | • | The non standardization between different synthesizers (which might |
| | | excess in direct flaws such as eccentric delays in some patches) can be |
| | | handled directly by the synth matrices so that the strengths of each |
| | | synthesizer model can be fully exploited when several synths are used |
| | | in one studio set-up. |
| Flexibility | • | Synth manufacturers or others may specify good default synth |
| | | matrices for their brands and models while individual users are given |
| | | the complete freedom of tailoring their own matrices to suit their own |
| | | specific taste and need and to switch between several such sets of |
| | | matrices by simple file replacements. |
| | • | New instruments or new synthesizers with significantly new qualities |
| | | along with new descriptors and their corresponding attribute sets can |
| | | be added by only writing new synth matrices to provide the minimum |
| | | quantity of information really needed (no general purpose |
| | | programming is necessary - but the flexibility of course depends a lot |
| | | on the application hosting the matrix driver since it might not be as |
| | | flexible as the matrix driver). |
| Musical | • | A very fundamental aspect of music played back by a musician or an |
| context | | ensemble of musicians is the musical context and this thought is an |
| | | integral part of the Generalized Synthesizers invention which opens |
| | | up possibilities for music playback processing far beyond any |
| | | previous attempts in the field of synthesized music. |
| | • | A number of important pieces of behavior is possible to handle in an |
| | | automated and flexible way; for example cross patch fading, trills, |
| | | expanding single voice instruments, imploding multiple voice |
| | | instruments, cross register fading and taking care of patch timing & |
| | | register flaws (all of these things have been described). |
| Ease of use | • | The instrument library and the mechanism to store and retrieve |
| | | information in this library structure greatly simplifies working with |
| | | groups of instruments which makes changes in the synth matrices |
| | | easier to perform and duplication of information unnecessary etc. |
| | • | The simplicity of the synth matrix file format makes it possible for |
| | | ordinary music application users to tailor their own musical behavior |
| | | to reflect subjective taste and opinions on how music is to be |
| | | interpreted. |
| | • | The thorough design of Genralized Synthesizers allows several |
| | | applications and even application types to use the same general matrix |
| | | driver construction and specifically to use exactly the same synth |
| | | matrix files, which further simplifies things both for the end users and |
| | | the writers of synth matrices, whether it be synthesizer manufacturers |
| | | or other third party suppliers. |

APPENDIX A
Sample instrument library

The following depicts a partial implementation of the instrument library which is

used in an actual music notation programme (Igor Engraver, see www.noteheads.com). Each
row corresponds to an instrument and the instrument name is preceded by names
symbolizing all the subgroups which the instrument belongs to from most general (close-to-
root) to most specific (close-to-leave).

The root level “Instrument” has been left out just to make the listing shorter, but it is

a valid group and is used to refer to all instruments as one group.
WIND: WOODWIND: FLUTE: Piccolo
WIND: WOODWIND: FLUTE: Flute in E flat
WIND: WOODWIND: FLUTE: Flute
WIND: WOODWIND: FLUTE: Alto Flute
WIND: WOODWIND: FLUTE: Bass Flute
WIND: WOODWIND: FLUTE: RECORDER: Sopranino recorder
WIND: WOODWIND: FLUTE: RECORDER: Soprano recorder
WIND: WOODWIND: FLUTE: RECORDER: Alto recorder
WIND: WOODWIND: FLUTE: RECORDER: Tenor recorder
WIND: WOODWIND: FLUTE: RECORDER: Bass recorder
WIND: WOODWIND: DOUBLE-REED: OBOE: Oboe in E flat
WIND: WOODWIND: DOUBLE-REED: OBOE: Oboe
WIND: WOODWIND: DOUBLE-REED: OBOE: Oboe d′amore
WIND: WOODWIND: DOUBLE-REED: OBOE: English Horn
WIND: WOODWIND: DOUBLE-REED: OBOE: Oboe da caccia
WIND: WOODWIND: DOUBLE-REED: OBOE: Baritone Oboe
WIND: WOODWIND: DOUBLE-REED: OBOE: Heckelphone
WIND: WOODWIND: SINGLE-REED: CLARINET: HIGH-CLARINET: Clarinet in E flat
WIND: WOODWIND: SINGLE-REED: CLARINET: HIGH-CLARINET: Clarinet in D
WIND: WOODWIND: SINGLE-REED: CLARINET: MID-CLARINET: Clarinet in C
WIND: WOODWIND: SINGLE-REED: CLARINET: MID-CLARINET: Clarinet in B flat
WIND: WOODWIND: SINGLE-REED: CLARINET: MID-CLARINET: Clarinet in A
WIND: WOODWIND: SINGLE-REED: CLARINET: LOW-CLARINET: BASS-CLARINET: Alto Clarinet
in E flat
WIND: WOODWIND: SINGLE-REED: CLARINET: LOW-CLARINET: BASS-CLARINET: Basset Horn
in F
WIND: WOODWIND: SINGLE-REED: CLARINET: LOW-CLARINET: BASS-CLARINET: Basset Horn
(Strauss) in F
WIND: WOODWIND: SINGLE-REED: CLARINET: LOW-CLARINET: BASS-CLARINET: Bass Clarinet,
French notation, in B flat
WIND: WOODWIND: SINGLE-REED: CLARINET: LOW-CLARINET: BASS-CLARINET: Bass Clarinet,
German notation, in B flat
WIND: WOODWIND: SINGLE-REED: CLARINET: LOW-CLARINET: BASS-CLARINET: Contra Alto
Clarinet in E flat
WIND: WOODWIND: SINGLE-REED: CLARINET: LOW-CLARINET: CONTRABASS-CLARINET:
Contrabass Clarinet, French notation, in B flat
WIND: WOODWIND: SINGLE-REED: CLARINET: LOW-CLARINET: CONTRABASS-CLARINET:
Contrabass Clarinet, German notation, in B flat
WIND: WOODWIND: SINGLE-REED: SAXOPHONE: Sopranino saxophone in E flat
WIND: WOODWIND: SINGLE-REED: SAXOPHONE: Soprano Saxophone in B flat
WIND: WOODWIND: SINGLE-REED: SAXOPEONE: Alto Saxophone in E flat
WIND: WOODWIND: SINGLE-REED: SAXOPHONE: Tenor Saxophone in B flat
WIND: WOODWIND: SINGLE-REED: SAXOPHONE: Baritone Saxophone in E flat
WIND: WOODWIND: SINGLE-REED: SAXOPHONE: Bass Saxophone in B flat
WIND: WOODWIND: SINGLE-REED: SAXOPHONE: Contrabass saxophone in E flat
WIND: WOODWIND: DOUBLE-REED: BASSOON: Bassoon
WIND: WOODWIND: DOUBLE-REED: BASSOON: Contrabassoon
etc.

APPENDIX B
Sample synth matrix files

Here are two partial examples of synth matrix files in a simple implementation

of the synth matrix file format used by the notation program Igor Engraver (see
www.noteheads.com). Upper-case denotes descriptors as defined in this application.
7 Synt matrix example: Roland JV-1010
;;;; ====================================
;;;; IGOR (tm) Synth Matrix
;;;; User-Readable Text Format
;;;;
;;;; (c) NoteHeads Musical Expert Systems AB (publ) MCMXCVIII
;;;; ====================================
Manufacturer “Roland”
Model “JV-1010”
GM-standard
Velocities 13 15 18 22 28 61 90 108 115 120
;;;; Velocities 10 12 15 19 25 56 85 105 111 120
;;;; Volumes 10 12 15 19 32 56 85 105 111 120
Volumes 13 15 18 22 35 61 91 108 115 120
Drum-channel 10
Patch-change-delay 40
Pitch-bend-range 2

| | |
|---|---|
| Author | “Peter Bengtson” |
| Comment | “This is for a JV-1010 with an Orchestral Expansion card (SR-JV80-02) |
| | installed in the expansion bay.” |

patch-offset gm 512
patch-offset orch 1024
;;;; ------------------------------------
;;;; INSTRUMENT class
;;;; ------------------------------------

| | |
|---|---|
| instrument-class INSTRUMENT | attributes ORD patch gm 0 |

;;;; ------------------------------------
;;;; WOODWIND class
;;;; ------------------------------------

| | |
|---|---|
| instrument-class WOODWIND | attributes ORD patch orch 149 |

;;;; ------------------------------------
;;;; FLUTE class
;;;; ------------------------------------

| | |
|---|---|
| instrument-class FLUTE | attributes ORD patch orch 86 octave −1 |
| | attributes PIANO patch orch 86 octave −1 |
| volume 1.1 | |
| | attributes FORTE patch orch 86 octave −1 |
| volume 0.8 | |
| | attributes NOVIB patch orch 87 octave −1 |
| | attributes ATTACK-ONLY PIANO patch orch 86 |
| octave −1 volume 1.1 | |
| | attributes ATTACK-ONLY FORTE patch orch 86 |
| octave −1 volume 0.8 | |
| | attributes ATTACK-ONLY patch orch 86 octave −1 |
| | attributes FAST patch orch 86 octave −1 |
| | attributes FAST PIANO patch orch 86 volume 1.1 |
| octave −1 | |
| | attributes FAST FORTE patch orch 86 volume 0.8 |
| octave −1 | |
| ; Piccolo | |
| instrument 10100 | attributes ORD patch orch 88 volume −40 |
| | attributes FORTE patch orch 88 volume −40 |
| | attributes PIANO patch orch 88 |
| ; Flute | |
| instrument 10200 | attributes ORD patch orch 86 octave −1 |
| | attributes PIANO patch orch 86 octave −1 |
| volume 1.1 | |
| | attributes FORTE patch orch 86 octave −1 |
| volume 0.8 | |
| | attributes NOVIB patch orch 87 octave −1 |
| | attributes ATTACK-ONLY PIANO patch orch 86 |
| octave −1 volume 1.1 | |
| | attributes ATTACK-ONLY FORTE patch orch 86 |
| octave −1 volume 0.8 | |
| | attributes ATTACK-ONLY patch orch 86 octave −1 |
| | attributes FAST patch orch 86 octave −1 |
| | attributes FAST PIANO patch orch 86 volume 1.1 |
| octave −1 | |
| | attributes FAST FORTE patch orch 86 volume 0.8 |
| octave −1 | |
| ; Shakuhachi | |
| instrument 43000 | attributes ORD patch gm 77 |
| ; Panpipe | |
| instrument 43050 | attributes ORD patch pm 75 |
| ; Ocarina | |
| instrument 43150 | attributes ORD patch pm 79 |

8 Synt matrix example: General MIDI
;;;; ====================================
;;;; IGOR (tm) Synth Matrix
;;;; User-Readable Text Format
;;;;
;;;; (c) NoteHeads Musical Expert Systems AR (publ) MCMXCVIII
;;;; ====================================

| | |
|---|---|
| Manufacturer “General MIDI” | ; Must be “Manufacturer” in order to work! |

GM- standard
Drum-channel 10
Patch-change-delay 100
Author “Daniel Ståhl”
;;;; ====================================
;;;; INSTRUMENT class
;;;; ====================================

| | |
|---|---|
| instrument-class INSTRUMENT | attributes ORD patch 0 |

;;;; ------------------------------------
;;;; FLUTE Class
;;;; ------------------------------------

| | |
|---|---|
| instrument-class FLUTE | attributes ORD patch 73 |
| ; Piccolo | |
| instrument 10100 | attributes ORD patch 72 |
| ; Flute | |
| instrument 10200 | attributes ORD patch 73 |
| ; Shakuhachi | |
| instrument 43000 | attributes ORD patch 77 |
| ; Panpipe | |
| instrument 43050 | attributes ORD patch 75 |
| ; Ocarina | |
| instrument 43150 | attributes ORD patch 79 |

1. A general synthesizer comprising:
a music application for managing an entered representation of music and mapping the representation in to a set of input vectors including pitch, duration, and descriptors;
at least one synthesizer matrix for mapping descriptors into synthesizer specific attributes;
a matrix driver for creating a data flow using said input vectors and synthesizer matrix;
at least one synthesizer device controlled by said created data flow.

2. A general synthesizer according to claim 1, wherein the synthesizer matrix is organised in an instrument library structure.

3. A general synthesizer according to claim 2, wherein the instrument library is hierarchical with instrument group names at the nodes and with instrument subgroup names at internal nodes, and actual instrument names at the leaves.

4. A general synthesizer according to claim 3, wherein an entry in the synthesizer matrix includes: an instrument or instrument group name, a descriptor, and a listing of which attributes should be used for that instrument and descriptor.

5. A general synthesizer according to claim 4, wherein the listing includes attribute names along with parameters to specify to what degree that attribute contributes to the resulting attribute parameter.

6. A general synthesizer according to claim 1, wherein the matrix driver is arranged to provide the music application with an API (Application Programmer's Interface) to transfer the music representation together with its musical context to the matrix driver.

7. A general synthesizer according to claim 6, wherein the API provides a set of descriptors which are the basic “colors” that the matrix driver can blend in different ways and with which it can “paint” the music to enhance the playback including characteristics such as pitches, durations and sound banks to convey the musical context.

8. A general synthesizer according to claim 6, wherein the music application is arranged to maintain the musical context in a form which can be transferred by the API to the matrix driver, and the matrix driver is arranged to to translate this music and context, through the descriptors transferred through the API, into the lower levelled attributes adapted to the synthesizer device.

9. A general synthesizer according to claim 6, wherein the matrix driver is arranged to handle instrument specific details.

10. A general synthesizer according to claim 9, wherein the matrix driver is arranged to provide cross patch fading, so that the music application has only to specify general or specific preferences for when cross patch fading is allowed and the matrix driver then asks the synthesizer matrix file in question if there are any patches to cross fade between.

11. A general synthesizer according to claim 9, wherein the matrix driver is arranged to provide trills, glissandi, an arpeggio, a tremolo as specified per instrument or patch basis.

12. A general synthesizer according to claim 9, wherein the matrix driver is arranged to provide expansion of single voice instruments.

13. A general synthesizer according to claim 9, wherein the matrix driver is arranged to provide implosion of multiple voice instruments.

14. A general synthesizer according to claim 9, wherein the matrix driver is arranged to provide compensation of register and patch flaws, so that an instrument has the possibility to be assigned different patches (or other low level attributes) for different musical contexts and to be assigned different patches across different parts of the register.

15. A general synthesizer according to claim 9, wherein the matrix driver is arranged to provide cross register fading to yield a smoother transition across the register when patches are changed.

16. A general synthesizer according to claim 9, wherein the matrix driver is arranged to provide compensation of patch timing flaws, whereby a patch is offset by a time constant.

17. A general synthesizer according to claim 6, wherein the matrix driver is arranged to handle dynamic channel allocation.

18. A general synthesizer according to claim 17, wherein two or more instruments with the same patch number may share the same channel.

19. A general synthesizer according to claim 17, wherein an instrument which is temporarily silent does not need a channel, and thus allows other instrument to be allocated that channel.

20. A general synthesizer according to claim 17, wherein the matrix driver is arranged to optimize the usage of channels such that identical instruments share the same channel.

21. A general synthesizer according to claim 18, wherein the matrix driver is arranged to measure musical contexts for merging two or more instruments with close musical contexts such that it can be decided which one of two musical contexts is closest to a third, and to merge the closest instruments.

22. A general synthesizer according to claim 21, wherein the matrix driver is arranged to optimize the usage of channels such that the same patch and exactly the same musical context is used for similar instruments.

23. A general synthesizer according to claim 22, wherein the measurement is combined with a second measurement which gives the “distance in sound” between two instrument names.

24. A synthesizer driver for controlling a general synthesizer comprising:
a matrix driver for creating a data flow using: input vectors provided by a music application for managing a representation of music; and at least one synthesizer matrix mapping descriptors into synthesizer specific attributes.

25. A matrix driver for creating a data flow for controlling a synthesizer device, comprising:
means for combining input vectors representing music including pitch, duration, and descriptors with synthesizer specific attributes.

26. A matrix driver according to claim 25, wherein the matrix driver is arranged to provide a music application with an API (Application Programmer's Interface) to transfer the music representation together with its musical context to the matrix driver.

27. A matrix driver according to claim 26, wherein the API provides a set of descriptors which are the basic “colors” that the matrix driver can blend in different ways and with which it can “paint” the music to enhance the playback including characteristics such as pitches, durations and sound banks to convey the musical context.

28. A matrix driver according to claim 26, wherein the matrix driver is arranged to translate the music representation and context, through the descriptors transferred through the API, into the lower levelled attributes adapted to the synthesizer device.

29. A matrix driver according to claim 25, wherein the matrix driver is arranged to handle instrument specific details.

30. A matrix driver according to claim 29, wherein the matrix driver is arranged to provide cross patch fading, so that the music application has only to specify general or specific preferences for when cross patch fading is allowed and the matrix driver then asks the synthesizer matrix file in question if there are any patches to cross fade between.

31. A matrix driver according to claim 29, wherein the matrix driver is arranged to provide trills, glissandi, an arpeggio, a tremolo as specified per instrument or patch basis.

32. A matrix driver according to claim 29, wherein the matrix driver is arranged to provide expansion of single voice instruments.

33. A matrix driver according to claim 29, wherein the matrix driver is arranged to provide implosion of multiple voice instruments.

34. A matrix driver according to claim 29, wherein the matrix driver is arranged to provide compensation of register and patch flaws, so that an instrument has the possibility to be assigned different patches (or other low level attributes) for different musical contexts and to be assigned different patches across different parts of the register.

35. A matrix driver according to claim 29, wherein the matrix driver is arranged to provide cross register fading to yield a smoother transition across the register when patches are changed.

36. A matrix driver according to claim 29, wherein the matrix driver is arranged to provide compensation of patch timing flaws, whereby a patch is offset by a time constant.

37. A matrix driver according to claim 25, wherein the matrix driver is arranged to handle dynamic channel allocation.

38. A matrix driver according to claim 37, wherein two or more instruments with the same patch number may share the same channel.

39. A matrix driver according to claim 37, wherein an instrument which is temporarily silent does not need a channel, and thus allows other instrument to be allocated that channel.

40. A matrix driver according to claim 37, wherein the matrix driver is arranged to optimize the usage of channels such that identical instruments share the same channel.

41. A matrix driver according to claim 38, wherein the matrix driver is arranged to measure musical contexts for merging two or more instruments with close musical contexts such that it can be decided which one of two musical contexts is closest to a third, and to merge the closest instruments.

42. A matrix driver according to claim 41, wherein the matrix driver is arranged to optimize the usage of channels such that the same patch and exactly the same musical context is used for similar instruments.

43. A matrix driver according to claim 42, wherein the measurement is combined with a second measurement which gives the “distance in sound” between two instrument names.

44. A synthesizer matrix mapping descriptors into synthesizer specific attributes, wherein the descriptors are a part of input vectors representing music provided by a music application.

45. A synthesizer matrix according to claim 44, wherein the synthesizer matrix is organised in an instrument library structure.

46. A synthesizer matrix according to claim 45, wherein the instrument library is hierarchical with instrument group names at the nodes and with instrument subgroup names at internal nodes, and actual instrument names at the leaves.

47. A synthesizer matrix according to claim 46, wherein an entry in the synthesizer matrix includes: an instrument or instrument group name, a descriptor, and a listing of which attributes should be used for that instrument and descriptor.

48. A synthesizer matrix according to claim 47, wherein the listing includes attribute names along with parameters to specify to what degree that attribute contributes to the resulting attribute parameter.

49. A method for playback of music using a general synthesizer comprising:
a music application for managing an entered representation of music and mapping the representation in to a set of input vectors including pitch, duration, and descriptors;
at least one synthesizer matrix for mapping descriptors into synthesizer specific attributes;
a matrix driver for creating a data flow using said input vectors and synthesizer matrix;
at least one synthesizer device controlled by said created data flow, including the steps of:
the matrix driver building a list of application atomic musical objects AAMOs along with their contexts, each AAMO consisting of one note or a chord with high level descriptors, an indication defined in the synth matrix or no special indication at all;
breaking apart each AAMO atom and translating it into a recursive lists of internediate musical objects LIMO, to allow further processing, each atomic elements of a LIMO consisting of pitch and duration together with a list of cycling data as well as a list of descriptors;
translating each element in the LIMO, using the cyclic information to directly describe one or two early musical objects, EMMOs, which can be translated directly into a synthesizer control (MIDI) event;
translating each EMMO into a synthesizer specific control (MIDI) event SSME; selecting a patch and combining the contribution of each descriptor to form all the low level attributes of synthesizer control (MIDI); and
selecting a channel and synthesizer for each SSME.

50. A method according to claim 49, wherein the music consists of AAMOs in sequence as well as AAMOs in parallell together with musical context defined both locally for one substructure only or globally, for all parallell AAMOs.

51. A method according to claim 49, wherein an EMMO is assigned specific descriptor values obtained from a general descriptor which may consist of scripted functions, together with the explicit start and duration values.
